(19) United States
(12) Patent Application Publication
(10) Pub. No.: US 2005/0214166 A1
(43) Pub. Date: Sep. 29, 2005

(54) Blood sample conveyor-analyzer system

(75) Inventor: Teruaki Itoh, Kumamoto-shi (JP)

Correspondence Address: NIXON & VANDERHYE, PC, 901 NORTH GLEBE ROAD, 11TH FLOOR, ARLINGTON, VA, 22203, US

(73) Assignee: IDS COMPANY, LTD., Kumamoto-shi (JP)

(21) Appl. No.: 11/081,666

(22) Filed: Mar. 17, 2005

(30) Foreign Application Priority Data
Mar. 24, 2004 (JP) 2004-086887

(51) Int. Cl. G01N 35/00

(52) U.S. Cl. 422/65; 422/63

(57) ABSTRACT

A blood sample conveyor-analyzer system including one or more sample racks which hold a plurality of test tubes containing blood samples, a conveyor path for use as a conveyor line which conveys the sample racks, an analyzer which is connected to the conveyor path and analyzes the blood samples in the test tubes loaded by the conveyor path, and a control sample unit which has one or more control racks stored with control samples, is connected to the analyzer or the middle of the conveyor path, and causes the control racks to be loaded into the analyzer.

### CROSS-REFERENCE TO RELATED APPLICATIONS

This application is based upon and claims the benefit of priority from prior Japanese Patent Application No. 2004-086887, filed Mar. 24, 2004, the entire contents of which are incorporated herein by reference.

### BACKGROUND OF THE INVENTION

1. Field of the Invention

This invention relates to a blood sample conveyor-analyzer system, in which a plurality of test tubes containing blood samples are held in a sample rack as they are loaded into an analyzer, whereby the blood samples are analyzed.

2. Description of the Related Art

In conducting various blood tests in the fields of biochemical analysis and the like, test tubes that contain blood samples are set in a centrifuge for centrifugation as a pretreatment for the test. Thereafter, serums in the test tubes (or serums in the centrifuged blood samples) are extracted, and the blood samples from which the serums are extracted are distributed into suitable test vessels and subjected to the blood tests.

In loading the blood samples in the test tubes by an analyzer and analyzing them for each test tube, a reaction condition is detected by injecting, for example, a reagent into the samples. In this case, a plurality of test tubes that contain the blood samples are held upright in a sample rack at a time, and are loaded into the analyzer by a conveyor line, such as a conveyor belt.

The analyzer analyzes the blood samples contained in the test tubes in the sample rack that is loaded in it, and stores a microcomputer with results of the analysis. The test tubes that contain the analyzed blood samples are stocked into the analyzer.

In order to check the analysis for normality, the analyzer of this type is loaded with control samples periodically or with every given amount of processing, thereby checking analysis data. The control samples are held upright in a control rack that resembles the sample rack when they are stored in a cool chamber or the like.

In this operation, an operator takes out the control samples in each entire control rack periodically or with every given amount of processing, loads them into the analyzer, and checks the analysis data to see if the analysis is normal.

In carrying out the operation described above, the operator must continually attend the analysis of the blood samples. Therefore, this operation is a burden on the operator. If the operator neglects to take out the control samples and load them into the analyzer, moreover, the analysis may possibly fail to be accurate.

### BRIEF SUMMARY OF THE INVENTION

A blood sample conveyor-analyzer system according to one aspect of the invention comprises one or more sample racks which hold a plurality of test tubes containing blood samples, a conveyor line which conveys the sample racks, an analyzer which is connected to the conveyor line and analyzes the blood samples in the test tubes loaded by the conveyor line, and a control sample unit which has one or more control racks stored with control samples, is connected to the analyzer or the conveyor line, and causes the control racks to be loaded into the analyzer.

Preferably, the control sample unit has a plurality of control racks, which are arranged side by side with the longitudinal direction thereof parallel to the direction of conveyance of the sample racks so that each of the control racks can be unloaded from the control sample unit toward the analyzer in response to an unloading command signal.

Further, the control sample unit has a plurality of control racks, which are arranged side by side with the longitudinal direction thereof different from the direction of conveyance of the sample racks so that each of the control racks can be turned to be in alignment with the conveyance direction of the sample racks and unloaded from the control sample unit toward the analyzer in response to an unloading command signal.

Furthermore, the control sample unit has an unloading section through which the sample racks are discharged, and the conveyor line has a junction connected to the unloading section, the junction being provided with a direction changing mechanism which changes the longitudinal direction of the control racks.

With use of the blood sample conveyor-analyzer system according to the one aspect of the invention, the control samples in each entire control rack can be automatically unloaded from a cool chamber or the like and loaded into the analyzer, so that the man-hour can be reduced, and an accurate analysis can be ensured.

Additional advantages of the invention will be set forth in the description which follows, and in part will be obvious from the description, or may be learned by practice of the invention. The advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is a front view showing a blood sample conveyor-analyzer system according to a first embodiment of the invention;

FIG. 2 is a schematic plan view showing the blood sample conveyor-analyzer system of FIG. 1;

FIG. 3 is a side view showing a state in which test tubes are held by a sample rack;

FIG. 4 is a front view showing a blood sample conveyor-analyzer system according to a second embodiment of the invention; and

FIG. 5 is a schematic plan view showing the blood sample conveyor-analyzer system of FIG. 4.

### DETAILED DESCRIPTION OF THE INVENTION

Embodiments of this invention will now be described with reference to the accompanying drawings.

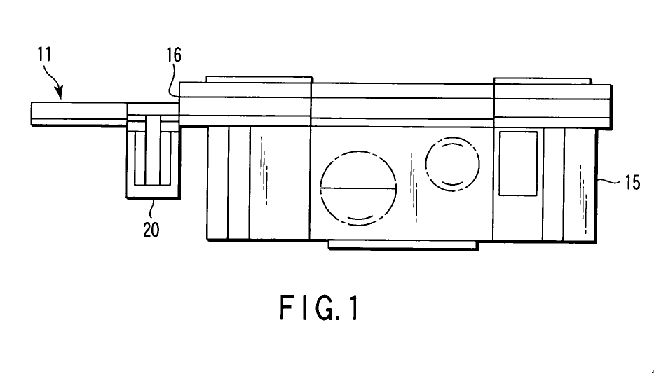

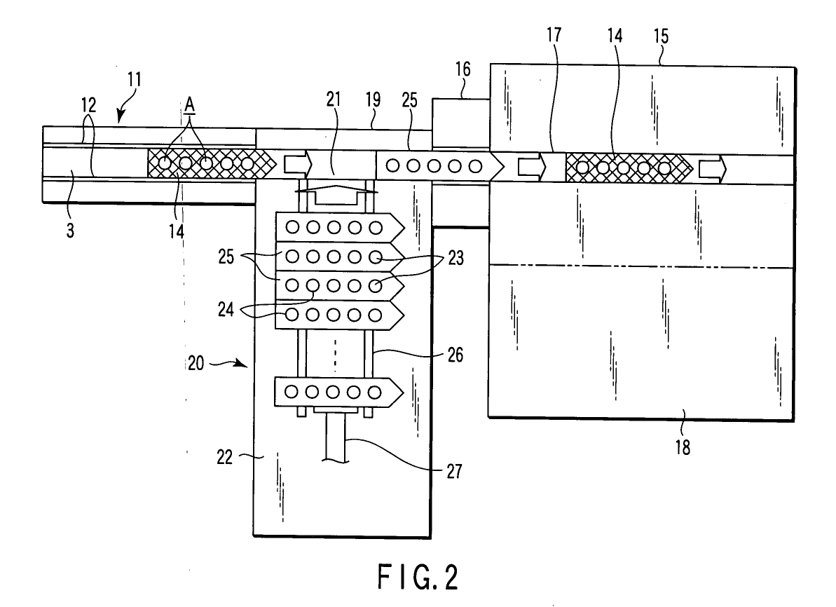

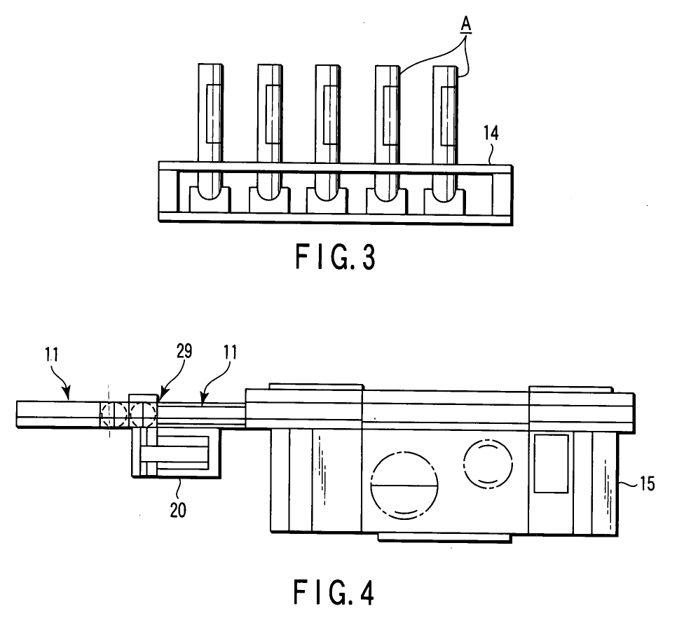

FIGS. 1 to 3 show a first embodiment. FIG. 1 is a front view of a blood sample conveyor-analyzer system, FIG. 2 is a plan view of the system, and FIG. 3 is a side view showing a state in which test tubes are held by a sample rack.

As shown in FIGS. 1 and 2, a conveyor path 11 for use as a conveyor line is provided with a pair of guide rails 12 and a conveyor belt 13. The rails 12 are set keeping a fixed width in the longitudinal direction. The belt 13 is located extending in the longitudinal direction between the rails 12. As shown in FIG. 3, a sample rack 14 can hold a plurality of, e.g., five, test tubes A that contain blood samples, individually. The rack 14 holds each test tube A upright or in a vertical state, for example.

The conveyor path 11 carries one or more sample racks 14 thereon and conveys them in a single column.

An analyzer 15 is provided at an outlet end of the conveyor path 11. It analyzes the blood samples in the test tubes A in each sample rack 14 that is carried in through the conveyor path 11. The analyzer 15 has a loading section 16 and a conveyor section 17 that continuously extends from the loading section 16 into the analyzer 15. The analyzer 15 is provided with a sensing element and a microcomputer (not shown). The sensing element detects a reaction condition by injecting a reagent into the blood samples in the test tubes A that are held in the sample rack 14. The microcomputer stores results of the detection. Located in the analyzer 15 is a stock section 18 that stores the sample racks 14 holding the test tubes A that individually contain the tested blood samples.

A junction 19 is provided between the outlet end of the conveyor path 11 and the loading section 16 of the analyzer 15. An unloading section 21 of a control sample unit 20 is connected to the junction 19. The unit 20 is provided with a cool chamber 22. Vessels 24 that individually contain control samples 23 are stored in the cool chamber 22. Each of control racks 25 can hold a plurality of, e.g., five, vessels (e.g., test tubes) 24. The vessels 24 are held upright or in a vertical state, for example, in each control rack 25. Each control rack 25 may be formed having basically the same construction as each sample rack 14. For ease of distinction between the sample racks 14 and the control racks 25, however, the sample racks 14 are hatched with a latticed pattern in FIG. 2.

The control sample unit 20 has a pair of unloading rails 26 that extend substantially at right angles to the pair of guide rails 12. The control racks 25 are placed on the unloading rails 26 in a manner such that they are arranged side by side with their longitudinal direction parallel to the conveyance direction of the sample racks 14 (direction in which the sample racks 14 are conveyed along the conveyor path 11).

A pusher mechanism 27 that carries out each control rack 25 from the unloading section 21 into the conveyor path 11 is located behind the unloading rails 26. The pusher mechanism 27 is actuated by an unloading command signal. When the control rack 25 is unloaded from the control sample unit 20, it is loaded into the analyzer 15 through the conveyor path 11.

According to the blood sample conveyor-analyzer system constructed in this manner, the sample racks 14 are loaded into the analyzer 15 through the loading section 16 as the conveyor belt 13 of the conveyor path 11 runs. The blood samples loaded into the analyzer 15 (or the blood samples contained in the test tubes A held by the sample racks 14) are subjected to desired detections (e.g., detection of the reaction condition through injection of the reagent, etc.) by the analyzer 15. Results of these detections are stored in the microcomputer or the like of the analyzer 15. At the same time, the sample racks 14 holding the test tubes A that individually contain the tested blood samples are stored in the stock section 18 of the analyzer 15.

The sample racks 14 that are loaded into the analyzer 15 are counted. If the count number reaches a preset value, e.g., several tens or hundreds, the unloading command signal is inputted to the control sample unit 20. As this is done, the pusher mechanism 27 is actuated to deliver the leading control rack 25 in the cool chamber 22 to the conveyor path 11.

The control rack 25 delivered to the conveyor path 11 is loaded into the analyzer 15 through the loading section 16. The analyzer 15 picks up the control samples 23 that serve as controls and checks analysis data to see if the analysis is normal. The control rack 25 that holds the tested control samples 23 are stored in the stock section 18 of the analyzer 15. Then, the sample racks 14 are delivered again from the conveyor path 11 and loaded into the analyzer 15, whereupon the analysis of the blood samples is restarted.

In the blood sample conveyor-analyzer system of the present embodiment, as described above, the sample racks 14 that are loaded into the analyzer 15 are counted. If the count number reaches the set value, e.g., several tens or hundreds, the unloading command signal is inputted to the control sample unit 20. Thereupon, one of the control racks 25 in the cool chamber 22 is delivered to the conveyor path 11. Then, it is automatically loaded from the analyzer 15 through the loading section 16. Thus, automatic operation can be performed without requiring man power. According to the conveyor-analyzer system of the present embodiment, therefore, the control samples in each entire control rack can be automatically unloaded from the cool chamber or the like and loaded into the analyzer. In consequence, the man-hour can be reduced, and an accurate analysis can be ensured.

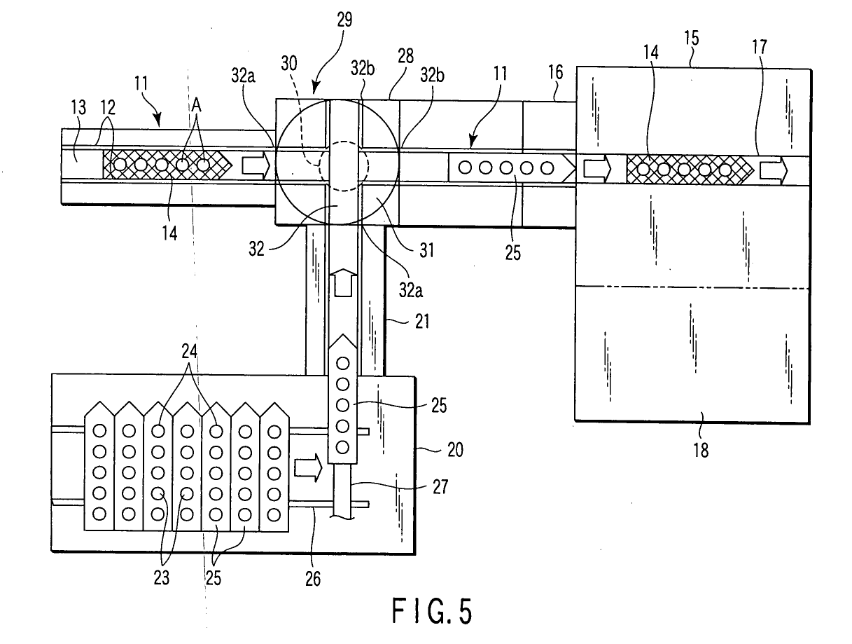

FIGS. 4 and 5 show a second embodiment. FIG. 4 is a front view of a blood sample conveyor-analyzer system, and FIG. 5 is a plan view of the system. Like numerals are used to designate like components of the first and second embodiments, and a description of those components is omitted.

A junction 28 is provided in the middle of a conveyor path 11 of the present embodiment. It connects an unloading section 21 of a control sample unit 20 and a conveyor path 11. The junction 28 is provided with a direction changing mechanism 29 for changing the direction of a control rack 25. The control sample unit 20 is provided with a pair of unloading rails 26 that extend substantially at right angles to a pair of guide rails 12. The control racks 25 are arranged so that their longitudinal direction is different from the conveyance direction of the sample racks 14, e.g., perpendicular to it. The control racks 25 are placed in alignment with one another in a cool chamber 22. Thus, the control racks 25 can be unloaded from the unloading section 21 in the same direction as their arrangement direction.

The direction changing mechanism 29 has a turntable 31 that is rotated by a reversible motor 30. The turntable 31 is provided with a cruciform rack support portion 32. Opposite end portions 32a and 32b of the rack support portion 32 rock within the horizontal plane of the turntable 31. The turntable 31 is formed in a manner such that the direction of the distal end of the unloading section 21 of the control sample unit 20 is alternatively switched between a direction perpendicular to and a direction parallel to the conveyor path 11 or that the unloading section 21 can rock within a range of, for example, about 90°. Thus, with use of the turntable 31, the longitudinal direction of each control rack 25 can be alternatively changed between the directions perpendicular to and parallel to the path 11.

According to this blood sample conveyor-analyzer system, the sample racks 14 that are loaded into an analyzer 15 are counted. If the count number reaches a preset value, e.g., several tens or hundreds, an unloading command signal is inputted to the control sample unit 20. As this is done, the leading control rack 25 in the cool chamber 22 is unloaded from the unloading section 21 into the rack support portion 32 of the turntable 31.

When the control rack 25 is transferred to the rack support portion 32, the turntable 31 is rocked clockwise for about 90° by the motor 30. Thereupon, the rack support portion 32 that supports the control rack 25 faces the conveyor path 11 (and the control rack 25 is placed on the conveyor path 11). If the control rack 25 unloaded by the sample rack 14 that is conveyed along the conveyor path 11 is pressed from behind in this state, it is loaded into the analyzer 15 through a loading section 16.

According to the present embodiment, the direction changing mechanism 29 is provided in the middle of the conveyor path 11. If the unloading command signal is inputted to the control sample unit 20, therefore, each control rack 25 in the cool chamber 22 can be conveyed to the conveyor path 11 without regard to the direction of arrangement of the control racks 25 in the control sample unit 20. Since each control rack 25 is automatically loaded from the conveyor path 11 into the analyzer 15 through the loading section 16, automatic operation can be performed without requiring man power. Thus, the same effect of the first embodiment can be obtained without regard to the arrangement direction of the control racks 25 in the control sample unit 20.

This invention is not limited directly to the embodiments described above, and its components may be embodied in modified forms without departing from the scope or spirit of the invention. Further, various inventions may be made by suitably combining a plurality of components described in connection with the foregoing embodiments. For example, some of the components according to the foregoing embodiments may be omitted. Furthermore, components according to different embodiments may be combined as required.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

1. A blood sample conveyor-analyzer system which comprises:
one or more sample racks which hold a plurality of test tubes containing blood samples,
a conveyor line which conveys the sample racks,
an analyzer which is connected to the conveyor line and analyzes the blood samples in the test tubes loaded by the conveyor line, and
a control sample unit which has one or more control racks stored with control samples, is connected to the analyzer or the conveyor line, and causes the control racks to be loaded into the analyzer.

2. A blood sample conveyor-analyzer system according to claim 1, wherein the control sample unit has a plurality of control racks, which are arranged side by side with the longitudinal direction thereof parallel to the direction of conveyance of the sample racks so that each of the control racks can be unloaded from the control sample unit toward the analyzer in response to an unloading command signal.

3. A blood sample conveyor-analyzer system according to claim 1, wherein the control sample unit has a plurality of control racks, which are arranged side by side with the longitudinal direction thereof different from the direction of conveyance of the sample racks so that each of the control racks can be turned to be in alignment with the conveyance direction of the sample racks and unloaded from the control sample unit toward the analyzer in response to an unloading command signal.

4. A blood sample conveyor-analyzer system according to claim 1, wherein the control sample unit has an unloading section through which the sample racks are discharged, and the conveyor line has a junction connected to the unloading section, the junction being provided with a direction changing mechanism which changes the longitudinal direction of the control racks.
